(19) United States
(12) Patent Application Publication
(10) Pub. No.: US 2008/0062486 A1
(43) Pub. Date: Mar. 13, 2008

(54) APPARATUS FOR RETROREFLECTING REFERENCE BEAM AND HOLOGRAPHIC INFORMATION RECORDING/REPRODUCING DEVICE EMPLOYING THE SAME

(75) Inventors: Taek-seong Jeong, Suwon-si (KR); Jong-chui Choi, Suwon-si (KR); Moon-il Jung, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/733,376

(22) Filed: Apr. 10, 2007

(30) Foreign Application Priority Data
Sep. 11, 2006 (KR) 2006-87465

(51) Int. Cl. G03H 1/10

(52) U.S. Cl. 359/10; 359/35

(57) ABSTRACT

Provided are an apparatus for retroreflecting reference beams and a holographic information recording/reproducing device employing the same. The apparatus for retroreflecting reference beams for use in a holographic information recording/reproducing device for recording/reproducing information on/from a holographic recording medium includes a lens focusing reference beams transmitted through the holographic recording medium at different incident angles with respect to the holographic recording medium to form spots at different positions in a focal plane; and a mirror disposed at the focal plane and retroreflecting the spots created by the lens toward the holographic recording medium.

### CROSS-REFERENCE TO RELATED APPLICATIONS

This application claims the benefit of Korean Application No. 2006-87465, filed Sep. 11, 2006, in the Korean Intellectual Property Office, the disclosure of which is incorporated herein by reference.

### BACKGROUND OF THE INVENTION

1. Field of the Invention

Aspects of the present invention relate to an apparatus for retroreflecting a reference beam and a holographic information recording/reproducing device employing the same.

2. Description of the Related Art

Holography allows an exact reproduction of original optical signals. Holographic technology makes it possible to reconstruct a signal as a stereoscopic image by recording an interference pattern between a data-carrying signal beam and a reference beam directed at a different angle from the signal beam. Considerable attention has recently been given to an optical storage technology for recording/reproducing digital data using holographic principles. According to holographic information recording/reproducing technology, a large amount of digital data can be recorded/reproduced in the form of two-dimensional (2D) images, one page at a time, thus allowing recording/reproducing of data at ultra-high speed. Holographic technology also allows information stored by multiplexing methods to be separately read. Thus, holographic technology enables ultra-high density storage.

FIG. 1A schematically illustrates the principle of recording data using holography. Referring to FIG. 1A, laser light 1 is separated by a beam splitter 2 into a reference beam 6 and a signal beam 5 that carries data to be stored. The signal beam 5 is modulated into a 2D signal pattern as it passes through a spatial light modulator 4 (SLM) and is then incident on a holographic recording medium D. The reference beam 6 is reflected by a mirror 3 and is incident on the holographic recording medium D at an angle. The reference beam 6 interferes with the signal beam 5 so that the resulting interference pattern is recorded on the holographic recording medium D.

FIG. 1B illustrates a principle of reproducing recorded data from a holographic recording medium D using holography. Referring to FIG. 1B, a laser 8 is used to irradiate a beam having the same wavelength as the reference beam 6 used in storing information onto the holographic recording medium D. In this case, the beam is irradiated at an angle equal to that at which the reference beam 6 for recording was irradiated during recording. After irradiation, a 2D signal pattern containing copies of the original information is reproduced and detected by a detector 9, such as a Charge Coupled Device (CCD), to achieve readout.

FIGS. 1A and 1B show that a reference beam propagates in the same direction during recording and reproduction. In this case, a signal beam propagates in opposite directions during recording and reproduction. However, conjugation reproduction is typically performed to cause a reference beam to travel in an opposite direction to a reference beam used during recording in order to integrate a transmitter for transmitting a signal beam and a receiver for receiving a signal beam into a single component and minimize adverse effects caused by aberrations of a lens. This requires the use of a separate structure for generating a reference beam traveling in an opposite direction to a reference beam for recording.

FIG. 2 illustrates a structure 10 for generating a reference beam traveling in an opposite direction to a reference beam used during recording. Referring to FIG. 2, light generated by a light source 11 is separated into two paths by a beam splitter 12. A reference beam L1 for recording is reflected by the beam splitter 12 and is then incident to a front surface of a holographic recording medium D after reflecting off of stationary mirrors 13a and 13b and rotating mirrors 14a and 14b. The two rotating mirrors 14a and 14b adjust the incident angle of the reference beam L1 for recording on the holographic recording medium D. A reference beam L2 for reproduction passes through the beam splitter 12 and is incident on the rear surface of the holographic recording medium D after reflecting off of stationary mirrors 15, 16a, and 16b and rotating mirrors 17a and 17b. The two rotating mirrors 17a and 17b make the incident angle of the reference beam L2 for reproduction equal to the incident angle of the reference beam L1 for recording.

According to the structure illustrated in FIG. 2, a transmitter for transmitting a signal beam and a receiver for receiving a signal beam are integrated into a single component because a signal beam for recording travels along the same path as for reproduction. However, use of the structure makes the entire holographic information recording/reproducing device bulky.

To overcome the above problem, one proposed approach is to retroreflect a reference beam. FIG. 3 illustrates a conventional apparatus 20 for retroreflecting a reference beam using a Galvano mirror for use in a holographic information recording/reproducing device. Referring to FIG. 3, a reference beam L1 from a light source 21 reflects off of a mirror 22 and a first Galvano mirror 23, passes through a scanner lens system 24 and is incident to a front surface of a holographic recording medium D. During recording, a signal beam is incident on the holographic recording medium D so that an interference pattern is recorded on the holographic recording medium D. During reproduction, a second Galvano mirror 25 retroreflects a reference beam that has passed through the holographic recording medium D back into the rear surface of the holographic recording medium D. The retroreflected reference beam is then diffracted as it passes through the rear surface of the holographic recording medium D to generate a signal beam L3. The signal beam L3 propagates along the same optical path as a signal beam for recording.

However, to achieve angle multiplexing, the conventional apparatus 20 requires separate driving units such as Galvano mirrors that can adjust the incident angle of a reference beam for reproduction. A typical retroreflector using a prism instead of a separate driving unit has a problem in that the position on the holographic recording medium D upon which a reference beam is incident changes. This requires increased control by an optical system for a holographic information recording/reproducing device. Furthermore, the use of expensive Galvano mirrors for precise control results in high manufacturing cost.

### SUMMARY OF THE INVENTION

Aspects of the present invention provide a simple and low-cost apparatus for retroreflecting reference beams without a separate driving unit, for use in a holographic information recording/reproducing device.

Additional aspects and/or advantages of the invention will be set forth in part in the description which follows and, in part, will be obvious from the description, or may be learned by practice of the invention.

According to an aspect of the present invention, there is provided an apparatus for retroreflecting reference beams for use in a holographic information recording/reproducing device for recording/reproducing information on/from a holographic recording medium, including: a lens focusing reference beams transmitted through the holographic recording medium at different incident angles with respect to the holographic recording medium to form spots at different positions in a focal plane; and a mirror disposed at the focal plane and retroreflecting the spots created by the lens toward the holographic recording medium.

The lens is disposed to obliquely face the holographic recording medium.

For example, the lens and the mirror may be perpendicular to the traveling direction of reference beams with an average incident angle of reference beams incident on the holographic recording medium.

The apparatus further includes a shutter blocking reference beams to prevent retroreflection of the reference beams while information is being recorded on the holographic recording medium.

The apparatus further includes a half-wave plate converting the polarization of reference beams in order to prevent retroreflection of the reference beams while information is being recorded on the holographic recording medium, wherein the mirror is a polarization-selective mirror that can reflect or absorb light according to the polarization of the light.

The mirror may be a rotatable mirror designed to prevent retroreflection of reference beams while information is being recorded on the holographic recording medium.

A portion of the lens other than the portion on which reference beams are incident also can be deleted from the apparatus to achieve the same result.

According to another aspect of the present invention, there is provided a holographic information recording/reproducing device including: a light source generating a light beam; a beam splitter splitting the light beam generated by the light source into two beams; a signal beam provider modulating one of the two separate beams into a signal beam having a two-dimensional (2D) signal pattern and providing the signal beam to a holographic recording medium; a photodetector detecting the signal beam; a reference beam incident angle controller allowing the other beam to be incident on the holographic recording medium as a reference beam; and an apparatus for retroreflecting a reference beam transmitted through the holographic recording medium back to the holographic recording medium, wherein the apparatus includes: a lens focusing reference beams transmitted through the holographic recording medium at different incident angles with respect to the holographic recording medium to form spots at different positions in a focal plane; and a mirror disposed at the focal plane and retroreflecting the spots created by the lens toward the holographic recording medium.

### BRIEF DESCRIPTION OF THE DRAWINGS

These and/or other aspects and advantages of the invention will become more readily appreciated from the following description of the embodiments, taken in conjunction with the accompanying drawings of which:

FIGS. 1A and 1B illustrate general principles of recording and reproducing data using holography in a holographic information recording/reproducing device;

FIG. 2 illustrates a conventional method for individually controlling reference beams for recording and reproducing in a holographic information recording/reproducing device;

FIG. 3 illustrates a conventional apparatus for retroreflecting a reference beam using Galvano mirrors for use in a holographic information recording/reproducing device;

FIG. 4 schematically illustrates an apparatus for retroreflecting reference beams for use in a holographic information recording/reproducing device according to an embodiment of the present invention;

FIGS. 5 and 6 schematically illustrate an apparatus for retroreflecting reference beams according to other embodiments of the present invention;

FIG. 7 illustrates an example of a lens with peripheral portions cut so that a reference beam is incident on a holographic recording medium; and

FIG. 8 illustrates the structure of a holographic information recording/reproducing device employing the apparatus of FIG. 4 according to an embodiment of the present invention.

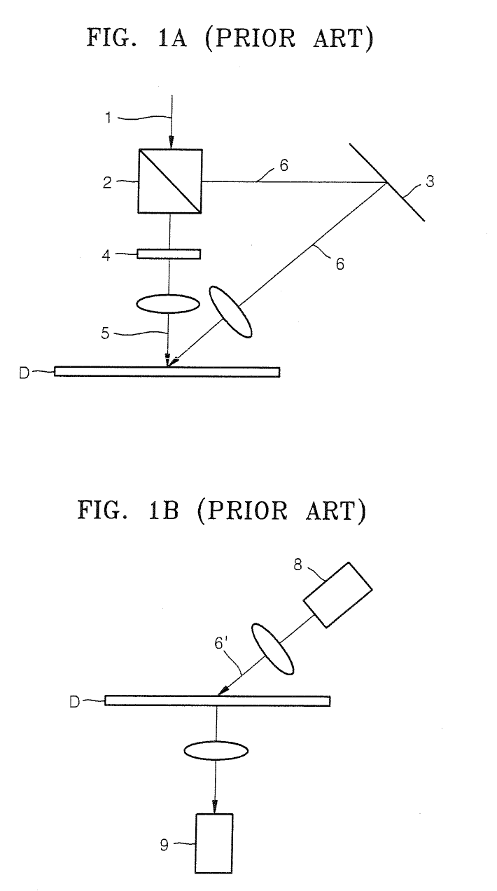

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 4 schematically illustrates an apparatus 30 for retroreflecting a reference beam for use in a holographic information recording/reproducing device according to an embodiment of the present invention. Referring to FIG. 4, the apparatus 30 includes a lens 31 focusing reference beams transmitted through a holographic recording medium D to form a spot on a focal plane and a mirror 32 retroreflecting the spot created by the lens 31 back through the holographic recording medium D.

Typically, a holographic information recording/reproducing device enables different data to be recorded at the same position by varying the incident angle of a reference beam using angle multiplexing in order to increase the recording density. A reference beam incident angle controller known in the art may adjust the incident angle of a reference beam so that the reference beam can irradiate the holographic recording medium D at different angles in order to achieve angle multiplexing. FIG. 4 shows reference beams L1 and L2 that are incident on the holographic recording medium D at different angles. For example, the first reference beam L1 is incident on the holographic recording medium D at the larger angle with respect to a line normal to the holographic recording medium D. The second reference beam L2 is incident thereon at the smaller angle with respect to the normal line. A reference beam may be incident on the holographic recording medium D at an angle between the incident angles of the first and second reference beams L1 and L2

The lens 31 focuses reference beams transmitted through the holographic recording medium D at different incident angles with respect to the holographic recording medium to form spots at different positions in a focal plane. Referring to FIG. 4, the first reference beam L1 passes through the holographic recording medium D and is incident at an upper portion of the lens 31. The first reference beam L1, which is a parallel beam, is focused to converge to a single spot on the focal plane by the lens 31. The second reference beam L2 passes through the holographic recording medium D and is incident at a lower portion of the lens 31. The second reference beam L2, which is a parallel beam, is focused to a single spot on the focal plane by the lens 31. Thus, the reference beam spots created by the lens 31 are positioned at upper and lower portions of the mirror 32.

The position of a spot on the mirror 32 is determined by the incident angle of a reference beam on the lens 31 with respect to an optical axis of the lens 31. That is, when f, θ, and y respectively denote a focal length of the lens 31, an angle of a reference beam incident on the lens 31 with respect to an optical axis, and a distance from the optical axis to a spot on the mirror 32, the relationship among them is defined by Equation (1):

y=f tan(θ) (1)

For example, when the focal length f of the lens 31 is 15 mm and a reference beam is incident on the lens 31 at an angle of about ±10° with respect to the optical axis, the spot is located about ±3 mm away from the optical axis. Thus, considering that a reference beam typically has a diameter of about 3 mm, the lens 31 and the mirror 32 may have a diameter of about 9 mm. The size of the lens 31 and the mirror 32 depends on the focal length of the lens 31. For example, if the focal length of the lens 31 is doubled to 30 mm, the diameter of the lens 31 and the mirror 32 will be increased to about 15 mm.

As the reference beam incident on the upper portion of the mirror 32 is reflected by the mirror 32 back into the upper portion of the lens 31, the first reference beam is transformed into a divergent beam. The first reference beam L1 is transformed back into a parallel beam as it passes through the upper portion of the lens 31 and is reincident on the holographic recording medium D. Similarly, the second reference beam L2 incident on the lower portion of the mirror 32 is reflected by the mirror 32, is transformed back into a parallel beam as it passes through the lower portion of the lens 31; and is returned to the holographic recording medium D.

The lens 31 and the mirror 32 are disposed to face the holographic recording medium D obliquely so that the reference beam retroreflected by the mirror 32 is incident on the holographic recording medium D along the original optical path. More specifically, the lens 31 and the mirror 32 are perpendicular to the traveling direction of a reference beam with an average incident angle of reference beams incident on the holographic recording medium D. For example, the lens 31 and the mirror 32 are disposed in such a manner that a central line between the incident angles of the first and second reference beams L1 and L2 is coincident with the optical axis of the lens 31 and the mirror 32. In this case, the reference beam reflected by the mirror 32 is incident at the rear surface of the holographic recording medium D while maintaining the same angle and the same incident position as when it is incident on the front surface thereof.

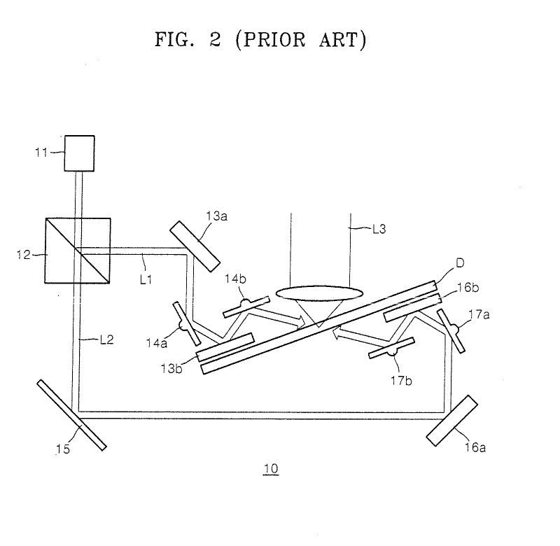

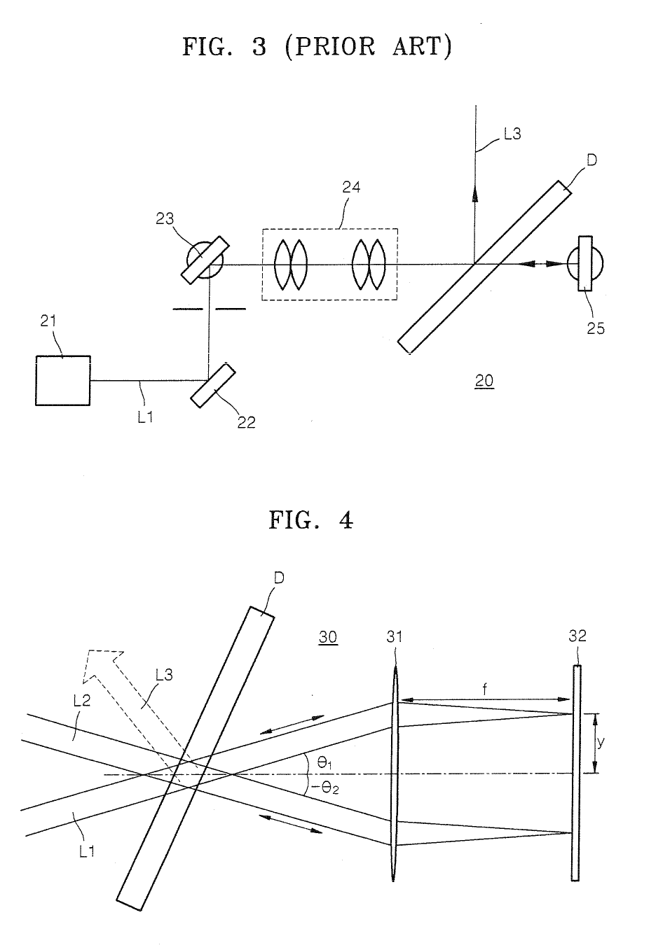

Thus, unlike the conventional approach illustrated in FIG. 2, the apparatus 30 for retroreflecting a reference beam according to an aspect of the present invention eliminates the need to separate a reference beam into two reference beams for recording and reproduction and individually adjusting the incident angles thereof. The apparatus 30 uses a single reference beam incident angle controller to adjust the incident angle of a reference beam during recording and reproduction. Furthermore, unlike the conventional method illustrated in FIG. 3, aspects of the present invention eliminate the need to drive a Galvano mirror at each incident angle of the reference beam because the retroreflected reference beam propagates along the original path. That is, the apparatus 30 does not require a separate driving unit.

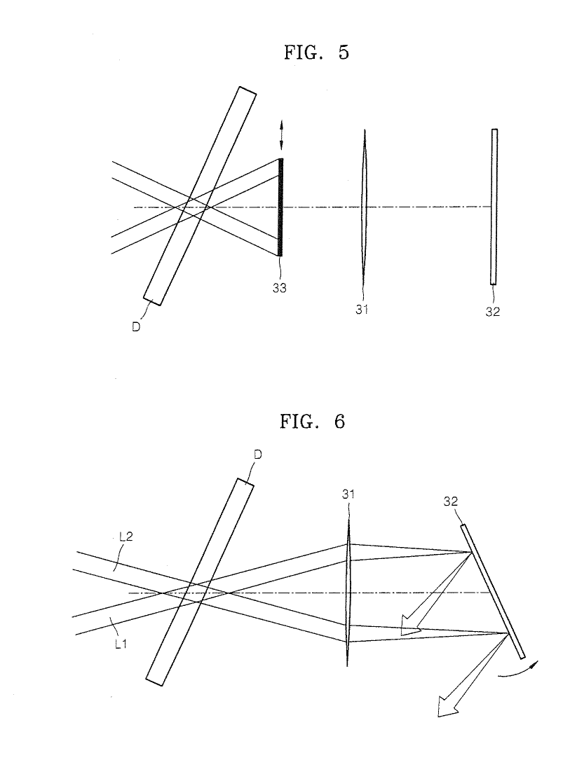

Meanwhile, it is necessary to prevent retroreflection of a reference beam that has passed through the holographic recording medium D during recording of information on the holographic recording medium D. FIGS. 5 and 6 illustrate structures for preventing retroreflection of a reference beam during recording.

Referring to FIG. 5, a shutter 33 may be disposed in an optical path between the holographic recording medium D and the mirror 32. While FIG. 5 shows the shutter 33 is disposed between the holographic recording medium D and the lens 31, it may be located between the lens 31 and the mirror 32. For example, the shutter 33 is closed while information is being recorded on the holographic recording medium D but is open to transmit a reference beam while information is being reproduced from the holographic recording medium D.

Referring to FIG. 6, a rotatable mirror 32 is used instead of the shutter 33 to prevent retroreflection of a reference beam during recording. That is, the mirror 32 rotates sufficiently while information is being recorded on the holographic recording medium D so as to cause a beam transmitted through the holographic recording medium D to the mirror 32 to be reflected along a path different than the original path, thus preventing the beam from returning to the holographic recording medium D. The mirror 32 rotates to return to the original position perpendicular to the optical axis while information is being reproduced from the holographic recording medium D.

Although not shown, an apparatus for retroreflecting a reference beam may further include a half-wave plate for converting the polarization of the reference beam in order to prevent retroreflection of the reference beam during recording. In this case, the mirror 32 is a polarization-selective mirror that can reflect or absorb light according to the polarization of the light. For example, the half-wave plate is located in an optical path between the holographic recording medium D and the mirror 32 during recording but is removed from the optical path during reproduction.

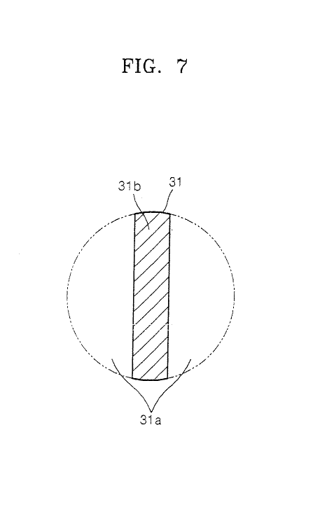

FIG. 7 illustrates an example of the lens 31 with just the central portion incorporated in the apparatus 30. That is, a reference beam is typically incident only on a portion of the lens 31, typically the central portion. This is shown in FIG. 7, where the reference beam is incident only on the central region 31b of the lens 31 indicated by cross hatching, not on the peripheral region 31a. Thus, incorporating only the central portion, 31b, of the lens does not affect the overall function of the lens 31. Rather, leaving off the peripheral region 31a can reduce the amount of material used to make the lens 31 as well as reducing the entire volume and weight of the apparatus 30.

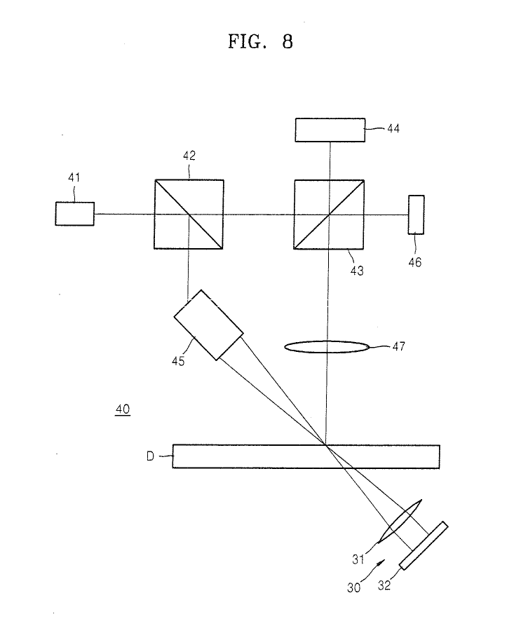

FIG. 8 illustrates optical arrangements for a holographic information recording/reproducing device 40 employing the apparatus of FIG. 4 according to an embodiment of the present invention.

Referring to FIG. 8, the holographic information recording/reproducing device 40 includes: a light source 41 emitting light; a first beam splitter 42 splitting the light generated by the light source 41 into two beams; a signal beam provider combination of 43, 44, and 47 which modulates one of the two separate beams into a signal beam having a two-dimensional (2D) signal pattern and provides the signal beam to the holographic recording medium D; a photodetector 46 detecting the signal beam; a reference beam incident angle controller 45 providing the other beam to the holographic recording medium D as a reference beam at a predetermined incident angle; and the apparatus 30 retroreflecting a reference beam transmitted through the holographic recording medium D to the holographic recording medium D.

The apparatus 30 may further include elements for preventing retroreflection of a reference beam during recording as illustrated in FIGS. 5 and 6. The signal beam provider 43, 44, and 47 includes a second beam splitter 43 reflecting the beam transmitted through the first beam splitter 42 to a spatial light modulator (SLM) 44, an SLM 44 modulating the beam incident from the second beam splitter 43 into a signal beam having a 2D signal pattern and reflecting the signal beam back into the second beam splitter 43, and an objective lens 47 focusing a signal beam onto the holographic recording medium D.

The recording operation of the holographic information recording/reproducing device 40 will now be described with reference to FIG. 8. Some of the light emitted by the light source 41 is transmitted through the first beam splitter 42 and used as a signal beam. The remaining part of the light is reflected by the first beam splitter 42 and used as a reference beam. The light transmitted through the first beam splitter 42 is reflected by the second beam splitter 43 to the SLM 44. The SLM 44 modulates the incident light into a signal beam having a 2D signal pattern and reflects the signal beam back to the second beam splitter 43. The signal beam is then transmitted through the second beam splitter 43 and is incident on the holographic recording medium D through the objective lens 47. In this case, the second beam splitter 43 may be a polarization beam splitter that can reflect light transmitted through the first beam splitter 42 and transmit light incident from the SLM 44. However, the construction and positions of the second beam splitter 43, the SLM 44, and the objective lens 47 may vary according to various design parameters. For instance, the SLM 44 may be disposed between the second beam splitter 43 and the objective lens 47. In this case, the SLM 44 may be transmissive. Thus, various changes may be made in the detailed construction of the signal provider 43, 44, and 47, depending on design parameters.

On the other hand, light reflected by the first beam splitter 42 is provided to the holographic recording medium D as a reference beam by the reference beam incident angle controller 45. The reference beam incident angle controller 45 adjusts the incident angle of the reference beam incident on the holographic recording medium D to a desired angle in order to achieve angle multiplexing. The reference beam incident angle controller 45 may have a known structure consisting of a plurality of rotating mirrors or Galvano mirrors.

The signal beam interferes with the reference beam within the holographic recording medium D to produce an interference pattern. The interference pattern is recorded on the holographic recording medium D. During recording, a shutter may be used to block an optical path within the apparatus 30, thus preventing a beam transmitted through the holographic recording medium D from being retroreflected back into the holographic recording medium D.

During the reproduction operation of the holographic information recording/reproducing device 40, a reference beam is incident on the holographic recording medium D along the same optical path as the reference beam used for recording. More specifically, a reference beam is reflected by the first beam splitter 42 and is then incident on the holographic recording medium D at an angle through the reference beam incident angle controller 45. In this case, the reference beam should be incident on the holographic recording medium D at the same angle as the reference beam used for recording. During reproduction, an optical path within the apparatus 30 is open, thus causing the reference beam to be retroreflected by the apparatus 30 after passing through the holographic recording medium D. As described above, the retroreflected reference beam is incident on the rear surface of the holographic recording medium D along its original optical path. The reference beam is then diffracted from the holographic recording medium D to generate a signal beam having a 2D signal pattern. The reproduced signal beam is reflected by the second beam splitter 43 and detected by the photodetector 46 such as a Charge Coupled Device (CCD) to read out a signal pattern stored on the holographic recording medium D.

A holographic information recording/reproducing device according to the present invention eliminates the need to separate the reference beam into reference beams for recording and reproduction and individually adjust the incident angles of the two separate reference beams. That is, the holographic information recording/reproducing device uses a single reference beam incident angle controller to adjust the incident angle of a reference beam during recording and reproduction. Thus, a simple holographic information recording/reproducing device can be provided. Aspects of the present invention also allow a retroreflected reference beam to propagate along the original path using only a lens and a mirror, thus eliminating the need for a separate driving unit. Thus, a compact, low-cost holographic information recording/reproducing device can be provided.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus for retroreflecting reference beams for use in a holographic information recording/reproducing device for recording/reproducing information on/from a holographic recording medium, the apparatus comprising:
a lens focusing reference beams transmitted through the holographic recording medium at different incident angles with respect to the holographic recording medium to form spots at different positions in a focal plane; and
a mirror disposed at the focal plane and retroreflecting the spots created by the lens toward the holographic recording medium.

2. The apparatus of claim 1, wherein the lens obliquely faces the holographic recording medium such that the reference beams retroreflected by the mirror are incident on the holographic recording medium along the original optical path.

3. The apparatus of claim 2, wherein the lens and the mirror are perpendicular to the traveling direction of the reference beams with an average incident angle of reference beams incident on the holographic recording medium.

4. The apparatus of claim 1, further comprising a shutter blocking reference beams to prevent retroreflection of the reference beams while information is being recorded on the holographic recording medium, wherein the shutter is disposed between the holographic recording medium and the lens or between the lens and the mirror.

5. The apparatus of claim 1, further comprising a half-wave plate converting the polarization of the reference beams to prevent retroreflection of the reference beams while information is being recorded on the holographic recording medium, wherein the mirror is a polarization-selective mirror that reflects or absorbs light according to the polarization of the light, and wherein the half-wave plate is located in the optical path between the holographic recording medium and the mirror during recording but is removed from the optical path during reproduction.

6. The apparatus of claim 1, wherein the mirror is a rotatable mirror to prevent retroreflection of the reference beams while information is being recorded on the holographic recording medium.

7. The apparatus of claim 1, wherein that portion of the lens necessary for focusing of the reference beams is incorporated in the apparatus.

8. A holographic information recording/reproducing device comprising:
a light source generating light beams;
a first beam splitter splitting each light beam generated by the light source into two beams;
a signal beam provider modulating one of the two separate beams into a signal beam having a two-dimensional (2D) signal pattern and providing the signal beam to a holographic recording medium;
a photodetector detecting the signal beam;
a reference beam incident angle controller allowing the other beam to be incident on the holographic recording medium as a reference beam; and
an apparatus for retroreflecting a reference beam transmitted through the holographic recording medium back to the holographic recording medium,
wherein the apparatus comprises:
a lens focusing reference beams transmitted through the holographic recording medium at different incident angles with respect to the holographic recording medium to form spots at different positions in a focal plane, and
a mirror disposed at the focal plane and retroreflecting the spots created by the lens toward the holographic recording medium.

9. The device of claim 8, wherein the lens obliquely faces the holographic recording medium such that the reference beams retroreflected by the mirror are incident on the holographic recording medium along the original optical path.

10. The device of claim 9, wherein the lens and the mirror are perpendicular to a traveling direction of the reference beams with an average incident angle of reference beams incident on the holographic recording medium.

11. The device of claim 8, wherein the apparatus further comprises a shutter blocking the reference beams to prevent retroreflection of the reference beams while information is being recorded on the holographic recording medium wherein the shutter may be disposed between the holographic recording medium and the lens or between the lens and the mirror.

12. The device of claim 8, wherein the apparatus further comprises a half-wave plate converting the polarization of the reference beams to prevent retroreflection of the reference beams while information is being recorded on the holographic recording medium,
wherein the mirror is a polarization-selective mirror that reflects or absorbs light according to the polarization of the light,
and wherein the half-wave plate is located in the optical path between the holographic recording medium and the mirror during recording but is removed from the optical path during reproduction.

13. The device of claim 8, wherein the mirror is a rotatable mirror to prevent retroreflection of the reference beams while information is being recorded on the holographic recording medium.

14. The device of claim 8, wherein that portion of the lens necessary for focusing of the reference beams is incorporated in the apparatus.

15. A method for recording holographic information comprising:
impinging light beams emitted from a source on a first beam splitter;
transmitting a first portion of the light impinging on the first beam splitter to a second beam splitter;
reflecting the light impinging on the second beam splitter into a spatial light modulator;
modulating the light reflected by the second beam splitter into signal beams having a 2D signal pattern and reflecting the signal beams back to the second beam splitter;
transmitting the signal beams through the second beam splitter and an objective lens;
impinging the signal beams on a holographic recording medium;
reflecting a portion of the light impinging on the first beam splitter from the first beam splitter;
passing the light reflected from the first beam splitter through a reference beam incident angle controller;
adjusting the angle of the beams from the reference beam incident angle controller to impinge on the holographic recording medium at an angle that creates angle multiplexing with the signal beams; and,
recording the interference patterns created by the interaction of the signal beams and the reference beams on the holographic recording medium.

16. A method for reproducing holographic information comprising:
reflecting beams from a first beam splitter through an incident angle controller to impinge on a holographic recording medium at the same incident angles as used for recording;
transmitting the beams from the incident angle controller through a holographic recording medium to an apparatus for retroreflecting the reference beams back to the rear surface of the holographic recording medium along the original optical path of the beams;
diffracting the beams from the holographic recording medium;
generating reproduced signal beams having a 2D signal pattern;
reflecting the reproduced signal beams by a second beam splitter to a photodetector; and,
reading the signal pattern stored on the holographic recording medium.

17. The apparatus of claim 1, wherein the diameter of the lens and the mirror are defined by the relationship y=f tan(θ) wherein θ is the angle of any reference beam incident on the lens, f is the focal length of the lens and y is the distance from the optical axis to a spot on the mirror.

18. The device of claim 8, wherein the signal beam provider comprises:
a second beam splitter;
a spatial light modulator;
an objective lens;
wherein the second beam splitter reflects the beams transmitted through the first beam splitter to the spatial light modulator;
wherein the spatial light modulator modulates the beams incident from the second beam splitter into signal beams having a two-dimensional signal pattern and reflects the signal beams back into the second beam splitter; and
wherein the objective lens focuses the signal beams onto the holographic recording medium.

19. The device of claim 8, wherein the diameter of the lens and the mirror are defined by the relationship y=f tan(θ) wherein θ is the angle of the reference beams incident on the lens, f is the focal length of the lens and y is the distance from the optical axis to a spot on the mirror
